(19) United States
(12) Patent Application Publication
(10) Pub. No.: US 2003/0111357 A1
(43) Pub. Date: Jun. 19, 2003

(54) Test meter calibration

(76) Inventor: Murdo M. Black, Martlesham (GB)

Correspondence Address: O'KEEFE, EGAN & PETERMAN, L.L.P., Building C, Suite 200, 1101 Capital of Texas Highway South, Austin, TX, 78746, US

(21) Appl. No.: 10/265,087

(22) Filed: Oct. 4, 2002

Related U.S. Application Data
(60) Provisional application No. 60/348,697, filed on Jan. 15, 2002.

(30) Foreign Application Priority Data
Dec. 13, 2001 (GB) GB0129883.5

(51) Int. Cl. G01N 27/26

(52) U.S. Cl. 205/775; 204/400; 204/401

(57) ABSTRACT

The invention provides a test meter (1) that may be calibrated using a calibration member (16). The calibration member (16) has at least one conductive region (38) of predetermined electrical resistance. The test meter (1) has at least two calibration electrodes (24), processor (34) and dispensing mechanism (22). The dispensing mechanism (22) can be used to dispense a calibration member (16) from the test meter (1). The conductive regions (38) of the calibration member make contact with the electrodes (24) as it is dispensed. The processor (34) receives a signal from the electrodes (24) as the calibration member (16) is dispensed. The processor (34) then processes said signal and generates a calibration signal to calibrate the test meter (1). The invention extends to a method of calibrating a test meter, a cartridge (18) for a test meter and a calibration member (16).

This application claims priority to co-pending United States provisional application serial No. 60/348,697 filed on Jan. 15, 2002 which is entitled “TEST METER CALIBRATION”, the disclosure of which is incorporated herein by reference. This application also claims priority to British patent application serial number 0129883.5 filed Dec. 13, 2001, the disclosure of which is also incorporated herein by reference.

### BACKGROUND OF THE INVENTION

1. Field of the Invention

The present invention relates to a test meter and method of calibrating same, particularly a test meter for testing blood glucose levels using a sample of whole blood.

2. Description of the Prior Art

Providing clinical products for the home test market, for instance a blood glucose meter (BGM), has several problems associated with it. It is important that the patient uses the product in the correct manner. Complete instructions for use are usually supplied with any such product, but there is no guarantee that a user will read such instructions. It is therefore important that the operation of such a clinical product is as simple and intuitive as possible.

In order for a diabetic patient to measure accurately their blood glucose concentration they typically use a BGM and a disposable test strip. The test strip will usually include an enzyme specific for β-D-glucose so that when a whole blood sample is added to the strip a reaction will occur. The reaction progress may be monitored using a chromogen included on the test strip to change colour as the reaction proceeds. The colour change can then be measured by the BGM using the reflectance of the strip. The reaction may also be followed by measuring the changing electrical properties of the strip as the reaction proceeds. Since the test strip includes a biological element it is very difficult to manufacture test strips with identical sensitivities. Manufacturers attempt to remedy this problem by calibrating batches of strips and assigning a code value to them that the BGM can interpret to calibrate itself.

The code value for a batch must be entered into the test meter for each batch of strips. This could be manually entered by a user, but errors may occur in the entry process, particularly for users with poor eyesight.

There have been a number of attempts to make the inputting of this information automatic and error free. These attempts have included the use of removable devices that can be inserted into the meter (U.S. Pat. No. 5,366,609) and altering the colour of the test strip substrate so that the meter can read the colour of the substrate to gain calibration information for that strip (U.S. Pat. No. 6,168,957). Other approaches have included printing a barcode on the test strip such that the test meter can read the barcode to gain calibration information (U.S. Pat. No. 4,476,149).

Calibration information has been included on a conductive strip on a colour-change test strip (U.S. Pat. No. 4,714,874). A signal is generated from the conductive strip by measuring the resistance ratio of the strip using three or more electrodes or probes. U.S. Pat. No. 5,160,278 describes a connector for connecting a reagent strip with encoded data to an analysing device. The connector has a plurality of generally U-shaped tungsten wires disposed about a generally cylindrical member fabricated from an elastomer to provide electrical contact with conductive areas on the reagent strip.

Calibration information has also been included on the package in which the test strips are supplied (U.S. Pat. No. 5,989,917) to be read automatically by the test meter.

The present invention seeks to provide an improved test meter and method of calibrating the meter.

### SUMMARY OF THE INVENTION

Accordingly, the invention provides a test meter that may be calibrated using a calibration member, the calibration member having at least one conductive region of predetermined electrical resistance, the test meter comprising at least two calibration electrodes, an electrical power source, processor and dispensing mechanism, the dispensing mechanism being operable to dispense a calibration member from the test meter, the or each conductive region of the calibration member making contact with the electrodes as it is dispensed, the electrodes and processor receiving power from the electrical power source, the processor receiving a signal from the electrodes, the signal being indicative of the current passing between them as the calibration member is dispensed, the processor processing said signal and generating a calibration signal to calibrate the test meter.

The invention thus provides a test meter that may be automatically calibrated using a calibration member. The calibration member may be supplied separately with test members from a particular batch. Preferably, however, the test meter includes a removable cartridge which contains at least one calibration member and a plurality of test members. In this case the dispensing mechanism is operable to dispense test members in sequence from the cartridge such that each test member makes contact with two test electrodes of the test meter as the test member is dispensed.

The dispensing mechanism may take any suitable form, for instance electrical, mechanical or a combination thereof.

A suitable dispensing mechanism is disclosed in the patent document WO 94/10558. Other suitable dispensing mechanisms will be known to persons skilled in the art.

The electrical power source is preferably a battery, but may be any other suitable source. The user could generate some of the electrical power, for instance by the action of actuating the dispensing mechanism. The power could be generated by the use of a generator converting the mechanical action of the user into electrical energy. It is to be understood that the electrical power source could comprise a plurality of separate power sources or supplies, for example a first battery for powering the processor and a second battery for energizing the electrodes. However, it is preferred that a single power source provides all the electrical power for the components of the meter.

Preferably a calibration member is dispensed from the cartridge prior to a test member being dispensed after a cartridge has first been inserted into the test meter. Usually a cartridge will contain test members from a single batch and a single calibration member can calibrate the test meter for the batch of test members before one is used. This helps to reduce the likelihood that that a new cartridge or batch of test members will be used without the meter being correctly calibrated.

It is usual that a test member will be in the form of a strip of substrate upon which there will be a test region including a reagent and a contact region for contacting the electrodes. The test member and calibration member could be any shape, but it is preferred that they are both strips of a similar size and shape such that they may be included in the same cartridge and dispensed using the same dispensing mechanism.

It is preferred that the calibration member is not a test member, ie that it does not carry reagent means. This enables the test member to be manufactured more easily and therefore more cheaply. However, it should be understood that a test member could also function as a calibration member by including conductive regions of predetermined resistance on the test member.

The calibration electrodes used to read the calibration data are preferably also the test electrodes used to measure an electrical characteristic of a test member during a test. This reduces the number of electrodes required in the test meter and hence reduces the complexity of manufacture.

The test meter may include a memory device connected to the processor. The memory device may receive power from the electrical power source and may be used to store calibration data relating to the operation of the test meter and test members. Preferably the calibration data is stored in a lookup table. This calibration data may be altered by a calibration signal from the processor.

The calibration data in a lookup table may be in the form of data points relating current passing between the electrodes to known concentrations of glucose in the blood sample. The processor can then process the signal from the electrodes and interpolate between the data points to determine the concentration of glucose in the sample.

The processor may comprise a plurality of elements that co-operate to process a signal from the electrodes, but will preferably comprise a single element.

The predetermined electrical resistance of the conductive regions of the calibration member may be indicative of the expected resistance of a test member including a sample having a predetermined characteristic corresponding to a data point in the lookup table. For example, depending upon the batch of test members, a glucose concentration in whole blood of 2 mM may produce a current in the region of 1-2 μA and this would correspond to a conductive region resistance of between 100 to 1100 ohms. An electrical resistance of a conductive region within this range could represent the result of a test member from a given batch with a sample of whole blood with a 2 mM glucose concentration. The data point for this concentration could be adjusted accordingly by the calibration signal. The electrical resistance of other conductive regions could represent other data points in the lookup table.

The calibration signal from the processor may include information indicative of a date, for instance a date of manufacture of the batch, an expiry or use-by date for the batch or other date sensitive information. The calibration signal could also include information indicative of temperature correction data. The test meter could then include a thermometer or similar device to measure temperature and automatically adjust the calibration data. This may be useful if a specific test to be performed by the meter is particularly temperature sensitive.

If a calibration member has a plurality of conductive regions, the test meter may count the number of regions to ensure that it has received the correct signal from the electrodes. If too few or too many conductive regions are measured, the test meter may require that the calibration member is reinserted and dispensed again until a satisfactory reading is obtained.

The calibration member may also include a conductive region of predetermined electrical resistance that is indicative of a signal to a test meter that the member being dispensed is a calibration member. This conductive region is preferably the first region to contact the electrodes and preferably has a resistance lower than that that could be reasonably be expected to result from a blood test with a test strip. This low resistance conductive region could also be used to ‘wake up’ the meter from a power saving state. The low resistance of this conductive region is to avoid the possibility of an incorrect reading by the test meter that the member is a calibration member. A further low resistance conductive region could be the last region to contact the electrodes and signal to the meter that the calibration is over.

The invention also provides a method of producing a calibration signal in a test meter, the test meter comprising at least two calibration electrodes, an electrical power source, processor, dispensing mechanism and a calibration member, the electrical power source supplying power to the electrodes and processor, the calibration member having at least one conductive region of predetermined electrical resistance, the method including the steps of:

a) using the dispensing mechanism to dispense said calibration member from the test meter, the or each conductive region of the calibration member making contact with the electrodes as the calibration member is dispensed;

b) using the electrodes to generate a signal indicative of the current passing between them as the calibration member is dispensed;

c) using the processor to receive the signal from the electrodes; and

d) using the processor to generate a calibration signal to calibrate the meter.

If the test meter includes a memory device for storing calibration data the method may include the step of using the calibration signal to alter the calibration data in the memory device. Preferably alteration of the calibration data only occurs after the calibration data stored in the memory device has been compared with the signal received from the electrodes. This means that if no change to the stored calibration data is required the calibration signal does not alter the stored data and this may help to prolong the life of any power supply within the test meter.

The invention also provides a cartridge for a test meter, the cartridge containing a plurality of test members for measuring analyte concentration in a fluid and at least one calibration member which is not a test member, the calibration member having at least one conductive region of predetermined electrical resistance, the calibration member being suitable for calibrating the test meter hereinbefore described.

Preferably the test members are arranged in a stack within the cartridge to be dispensed in sequence and a calibration member is at a position in the stack to be dispensed first.

The predetermined electrical resistance of a conductive region of the calibration member may be indicative of an expected response of a test member including a sample having a predetermined characteristic.

The cartridge may contain a plurality of calibration members so as to maintain a check on the test meter performance over time and ensure that the meter is correctly calibrated. It is also be possible that test members from several batches are included within the same cartridge and a calibration member may be included to recalibrate the meter as test members from a different batch are to be used.

The calibration member preferably includes a plurality of conductive regions. Each conductive region may have a predetermined electrical resistance indicative of calibration data for a test meter.

The calibration member is preferably axially elongate in the form of a strip and it is preferred that the dimensions of the calibration member are substantially the same as a test member. Preferably a plurality of conductive regions pass transverse to the axis of the strip to form conductive bands across the strip.

If the calibration member is not a test member, it is preferred that the calibration member has a distinctive appearance so that it does not look similar to a test member. This will prevent a user from trying to perform a test using a calibration member. The distinctive appearance may be provided by the conductive regions, but may be provided by graphics, writing or colours on the calibration member or test member.

The resistance of the conductive regions is preferably within the range of 20 ohms to 1M ohm and the predetermined resistance preferably has one of at least 10 possible values.

The invention further provides a method of calibrating a test meter using a calibration strip, the test meter being suitable for measuring a characteristic of a sample placed on a test strip dispensed from the meter, the test meter comprising at least two electrodes, an electrical power source, test strip dispensing mechanism, processor, a memory unit, the memory unit including data in a lookup table, the electrical power source supplying power to the electrodes, processor and memory device, the test strip dispensing mechanism being actuable to dispense a test strip from within the test meter, said test strip making contact with the electrodes as it is dispensed, the processor being electrically connected to the at least two electrodes to receive a signal from the electrodes indicative of the current passing between the electrodes, the processor comparing said signal with the lookup table to produce a signal indicative of a characteristic of a sample on a test strip, the calibration strip comprising at least one conductive region of predetermined electrical resistance corresponding to the expected electrical resistance of a test strip including a sample having a predetermined characteristic, wherein the method comprises the steps of:

a) inserting the calibration strip into the test meter;

b) using the dispensing mechanism to dispense said calibrating strip such that the or each conductive region makes contact with the electrodes;

c) using the processor to compare the signal received from the electrodes when in contact with a conductive region with the data in the lookup table for the predetermined characteristic; and

d) using the processor to alter the data in the lookup table in response to a difference between the signal and the data in the lookup table.

Other aspects and benefits of the invention will appear in the following specification, drawings and claims.

### BRIEF DESCRIPTION OF THE DRAWINGS

The invention will now be further described, by way of example, with reference to the accompanying drawings, in which:

FIG. 1 shows a test meter in accordance with an embodiment of the present invention, suitable for receiving a cartridge containing test members;

FIG. 2 shows a schematic representation of a cross section of the components within a test meter that may be used to calibrate the test meter using a calibration member according to an embodiment of the invention;

FIG. 3 shows a calibration member suitable for use with embodiments of the present invention;

FIG. 4 shows a calibration member being dispensed from a test meter in accordance with an embodiment of the invention, making contact with the electrodes;

FIG. 5 shows an exploded diagram of an embodiment of an electrode assembly suitable for use with the present invention; and

FIG. 6 illustrates a calibration member formed in accordance with a preferred method of manufacture.

### DETAILED DESCRIPTION

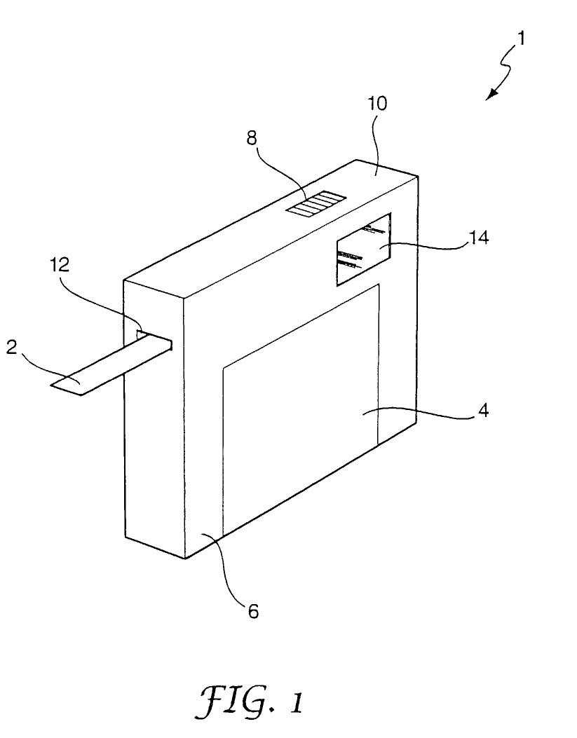

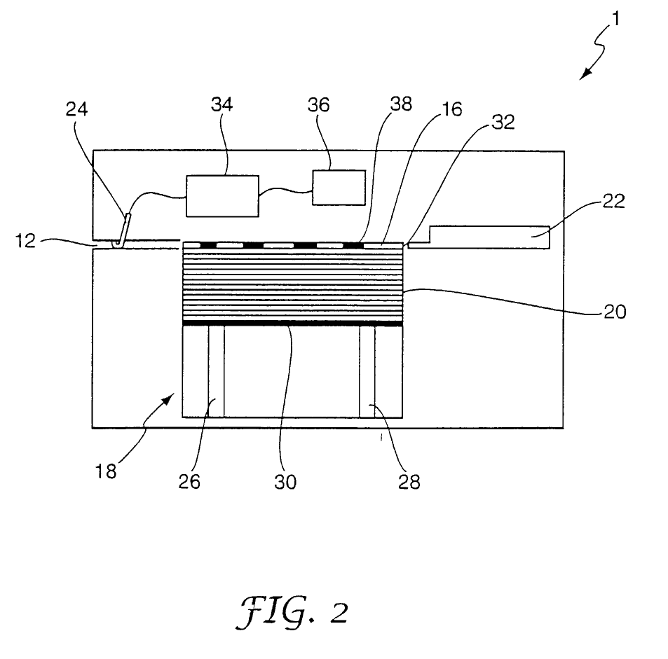

FIGS. 1 and 2 show a test meter 1 for use in testing the glucose concentration in a whole blood sample (not shown) using a test member 2. The test meter 1 includes a flap 4 in one side 6 to allow access to the interior of the test meter 1. Access to the interior of the test meter is required to insert a test member 2, calibration member 16 or a cartridge 18 containing test members 2.

A button 8 is included on an upper surface 10 of the test meter 1 to allow actuation of dispensing mechanism 22 to dispense a test member 2 from within the test meter 1 through a dispensing aperture 12. Actuation of the dispensing mechanism 22 by the button 8 may be electrical or mechanical. Electrical actuation of the dispensing mechanism 22 may be through the use of a motor, and mechanical actuation may be through the use of gears and racks.

In this embodiment the test member 2 has a test portion including an enzyme specific to β-D-glucose and a connecting portion. The connecting portion includes two electrodes connected to the test portion such that the electrodes 24 within the test meter 1 can measure the electrical conductivity of the test portion by making contact with the electrodes in the connecting portion.

A dispensed test member 2 remains partially within the dispensing aperture 12 so that the connecting portion of the test member 2 is in contact with electrodes 24 within the test meter 1. Placing a sample of whole blood on the test portion of the test member 2 begins a test. The electrodes 24 send a signal indicative of the current passing between them to a processor as the reaction between the enzyme and the glucose in the blood sample proceeds. The signal is indicative of an electrical characteristic of the test portion of the test member 2. The processor 34 processes the signal from the electrodes 24 and calculates a glucose concentration based on current calibration data held in a memory device 36 of the test meter 1. The glucose concentration is then displayed on a display means 14. The used test member 2 may then be manually removed from the dispensing aperture 12 and disposed of.

FIG. 2 shows schematically the components within the test meter 1 that may be used to generate a calibration signal and hence calibrate the test meter 1. A calibration member 16 is in the test meter 1 contained within a cartridge 18 containing a plurality of test members 2 arranged in a stack 20.

The calibration member 16 includes conductive regions 38 of predetermined electrical resistance. The predetermined electrical resistance of the conductive regions 28 is indicative of calibration information for test members 2 within the cartridge 18.

Dispensing mechanism 22 may be actuated to push a calibration member 16 or test member 2 from a top 32 of the cartridge 18 and out of the dispensing aperture 12. The cartridge 18 includes spring means 26,28 and a pushing member 30 to force the stack 20 of test members 2 to the top 32 of the cartridge 18.

As a calibration member 16 or test member 2 is pushed out of the dispensing aperture 12, it makes contact with two electrodes 24. The electrodes 24 are connected to processor 34. The processor 34 receives a signal from the electrodes 24 indicative of the current passing between them through the test member 2 or calibration member 16.

The processor 34 is connected to a memory device 36. The memory device 36 contains calibration data in a lookup table.

To calibrate the test meter 1, a cartridge 18 containing a calibration member 16 is inserted into the meter 1. The dispensing mechanism 22 is actuated to push the calibration member 16 out of the dispensing aperture 12. As the calibration member 16 is pushed out of the dispensing aperture 12, the electrodes 24 make contact with the conductive regions 38 of the calibration member 16 and send a signal to the processor 34 indicative of the predetermined resistance of the conductive regions 38.

The processor 34 processes this signal and compares the calibration data from the calibration member 16 with the calibration data stored in the memory device 36. If the calibration data are different, the processor 34 generates a calibration signal to calibrate the test meter 1 for the test members in the cartridge 16. The calibration signal alters the calibration data stored in the memory device 36.

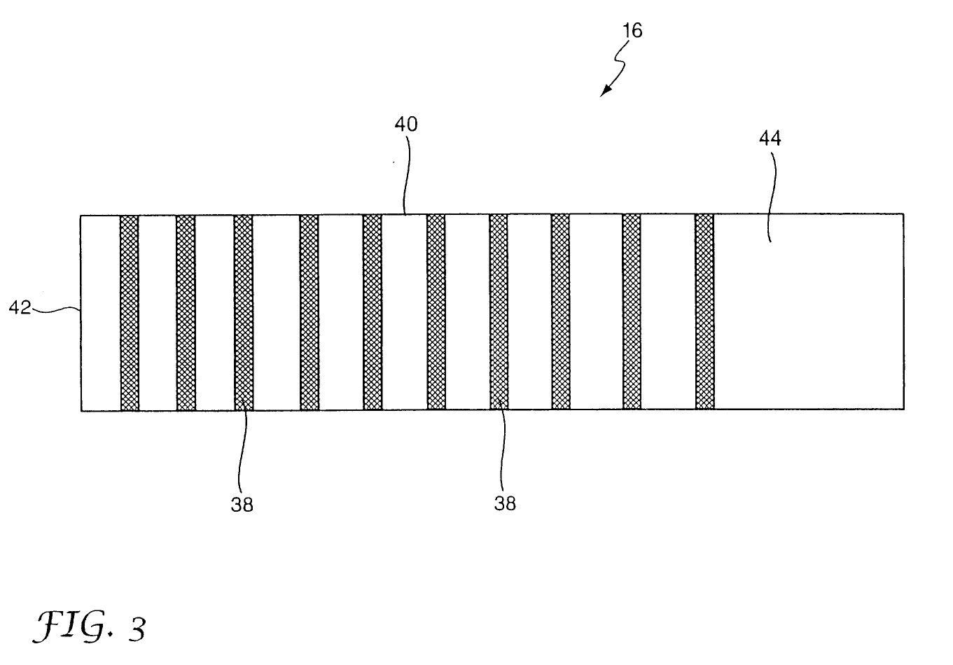

FIG. 3 shows a plan view of a calibration member 16. The calibration member 16 comprises a substantially rectangular axially elongate substrate 44 having a long edge 40 and a short edge 42 and includes a plurality of conductive regions 38 in the form of bands distributed along the substrate 44, the bands being transverse to the long edge 40 and substantially parallel with the short edge 42.

At least some of the conductive regions 38 have a predetermined electrical resistance indicative of calibration data for a test meter 1. The conductive regions 38 are created from a material of known resistance such as resistive tape adhered to the substrate 44. The conductive regions 38 could additionally or alternatively be screen-printed onto the substrate 44. Some of the conductive regions may have a predetermined resistance indicative of a signal to the test meter to ‘wake up’ from a power saving state, or a signal to the meter that a calibration member has started or finished passing through the electrodes 24.

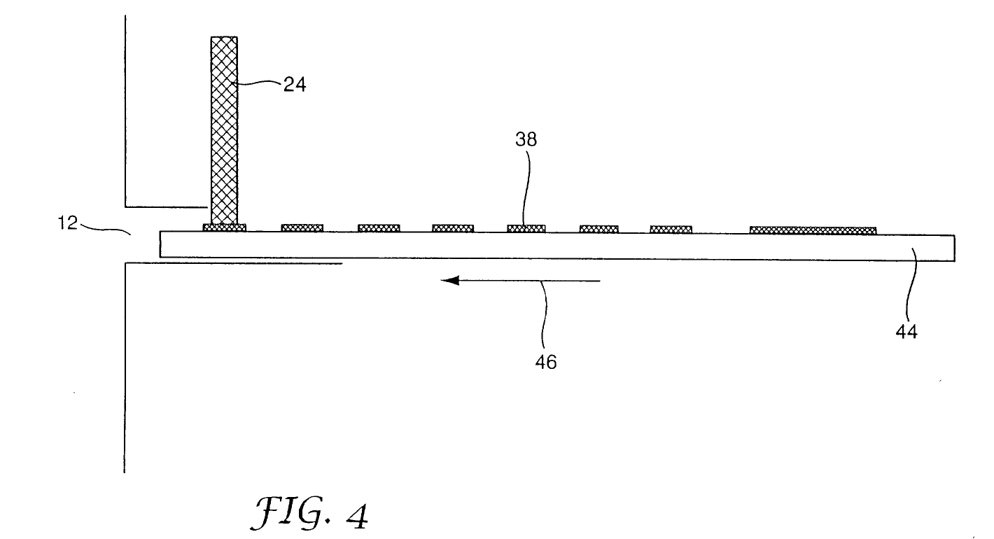

FIG. 4 shows a cross section view of a calibration strip 16 passing under electrodes 24 as it is pushed out of the test meter 1 in the direction of the arrow 46. The electrodes 24 are resiliently movable, in this case they are sprung, such that they may accommodate variations in the thickness of substrate 44 and conductive regions 38 whilst maintaining contact with the member as it is dispensed.

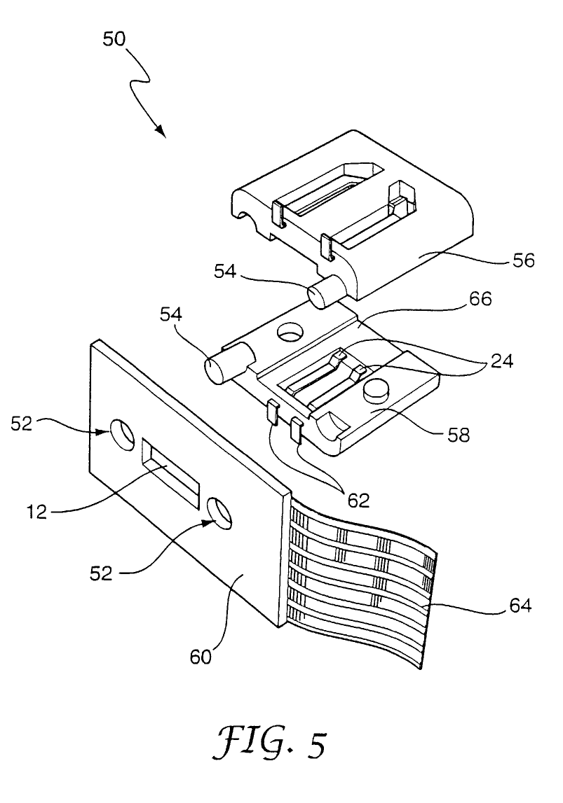

FIG. 5 shows an exploded diagram of an electrode assembly 50 suitable for use with the present invention. As a test member 2 or calibration member 16 is dispensed it passes along a channel 66 and out of the dispensing aperture 12. As it is dispensed, the member 2,16 makes contact with electrodes 24. The electrodes 24 are spring mounted within a two part housing comprising an upper member 56 and lower member 58 that together define the channel 66. The upper member 56 and lower member 58 include projections 54 that fit within holes 52 in a front panel 60 of the test meter when the electrode assembly 50 is assembled. When assembled, connectors 62 make contact with a flexible electrical connector 64 to provide signals to the processor 34.

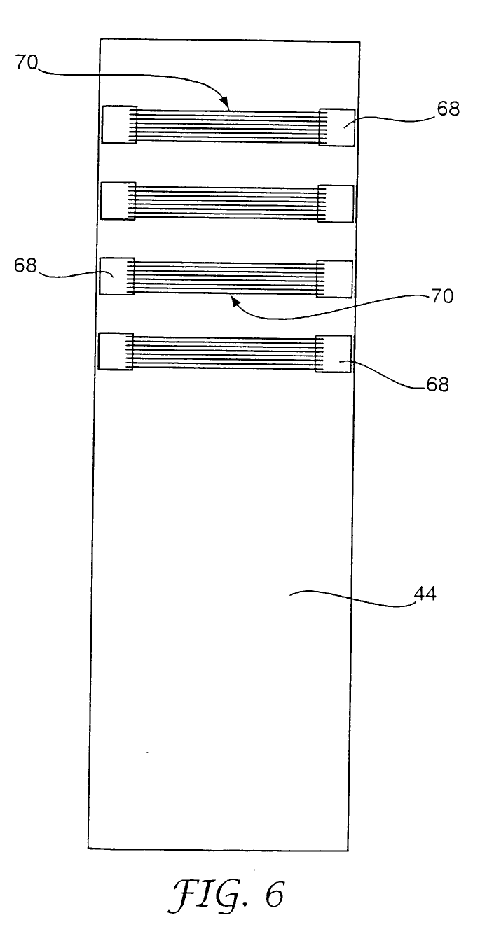

A preferred method of manufacture will now be described with reference to the calibration member shown in FIG. 6. Conductive pads 68, for example of silver or carbon, are printed on a suitable substrate 44, for example of a structural plastics material such as polyester, or other suitable material such as Veroboard™ or a ceramic material. Tracks 70 of a conductive material, for example silver or carbon, are printed down on the substrate so as to make electrical contact between opposed pads 68. A preferred printing technique is screen printing, but other suitable printing methods may also be employed. The resistance between connected pads 68 (measured across all of the tracks connecting the two pads) can be adjusted by etching away parts of one or more of the conductive tracks 70. Laser etching is preferably used, and the etching may be controlled automatically by a controller linked to resistance-measuring apparatus which stops etching of a particular set of tracks when a desired resistance is measured. To achieve a greater variation in resistances, a plurality of tracks may be laid down on top of each other. This method permits regions of different and precisely controlled resistance to be formed from a starting blank with identical regions of the same resistance. The calibration member illustrated has four identical conductive regions, but any number of such regions may of course be provided within the space constraints of the substrate 44. Typically, each track in a group is around 100 μm wide, and the tracks are spaced 100 to 150 μm apart.

Since a test meter according to the invention is calibrated using the same action that the user would perform to dispense a test member, calibration of the meter is less likely to be incorrectly performed. A calibration member can be included in a cartridge of test members and thus the test meter is calibrated without the user having to remember to perform any special actions.

It should be understood that the invention has been described above by way of example only and that those skilled in the art may make modifications in detail that fall within the spirit and scope of the invention.

1. A test meter that may be calibrated using a calibration member, the calibration member having at least one conductive region of predetermined electrical resistance, the test meter comprising at least two calibration electrodes, an electrical power source, processor and dispensing mechanism, the dispensing mechanism being operable to dispense a calibration member from the test meter, the or each conductive region of the calibration member making contact with the electrodes as it is dispensed, the electrodes and processor receiving power from the electrical power source, the processor receiving a signal from the electrodes, the signal being indicative of the current passing between them as the calibration member is dispensed, the processor processing said signal and generating a calibration signal to calibrate the test meter.

2. A test meter as claimed in claim 1, in which the test meter includes a cartridge removably inserted therein, the cartridge containing a plurality of test members, the dispensing mechanism being operable to dispense test members in order from said cartridge such that each test member makes contact with two test electrodes of the test meter as the test member is dispensed.

3. A test meter as claimed in claim 2, in which the cartridge includes at least one calibration member therein.

4. A test meter as claimed in claim 3, in which a calibration member is dispensed from the cartridge prior to the test member from said cartridge being used for testing.

5. A test meter as claimed in claim 1, in which the calibration member is not a test member.

6. A test meter as claimed in claim 2, in which the test electrodes and the calibration electrodes are the same electrodes.

7. A test meter as claimed in claim 1, in which the test meter is for testing a characteristic of a bodily fluid applied to a test member dispensed from the test meter.

8. A test meter as claimed in claim 7, in which the bodily fluid is whole blood.

9. A test meter as claimed in claim 8, in which the characteristic is blood glucose level.

10. A test meter as claimed in claim 1, in which the test meter further includes a memory device connected to the processor, the memory device storing calibration data.

11. A test meter as claimed in claim 10, in which the memory device stores the calibration data in a lookup table.

12. A test meter as claimed in claim 10, in which the calibration signal from the processor may- alter the calibration data stored in the memory device.

13. A test meter as claimed in claim 1, in which the calibration signal from the processor includes information indicative of a date.

14. A test meter as claimed in claim 1, in which the calibration member is of substantially the same dimensions as a test member.

15. A method of producing a calibration signal in a test meter, the test meter comprising at least two calibration electrodes, an electrical power source, processor, dispensing mechanism and a calibration member, the electrical power source supplying power to the electrodes and processor, the calibration member having at least one conductive region of predetermined electrical resistance, the method including the steps of:
a) using the dispensing mechanism to dispense said calibration member from the test meter, the or each conductive region of the calibration member making contact with the electrodes as the calibration member is dispensed;
b) using the electrodes to generate a signal indicative of the current passing between them as the calibration member is dispensed;
c) using the processor to receive the signal from the electrodes; and
d) using the processor to generate a calibration signal to calibrate the meter.

16. A method as claimed in claim 15, in which the test meter includes a memory device storing calibration data, the method including the step of using the calibration signal to alter the calibration data in the memory device

17. A method as claimed in claim 16, in which the calibration signal is generated only after the calibration data stored in the memory device has been compared with the signal received from the electrodes.

18. A method as claimed in claim 15, in which the test meter is adapted to receive a cartridge, the cartridge containing a plurality of test members, the dispensing mechanism being operable to dispense a test member from said cartridge such that the test member makes contact with two test electrodes of the test meter as the test member is dispensed and the calibration member is inserted into the test meter within a cartridge.

19. A method as claimed in claim 18, in which the predetermined resistance of the conductive region of the calibration member in a cartridge is indicative of calibration data for at least one of the test members in said cartridge.

20. A method as claimed in claim 15, in which the said calibration member is not a test member.

21. A cartridge for a test meter, the cartridge containing a plurality of test members for measuring analyte concentration in a fluid and at least one calibration member which is not a test member, the calibration member having at least one conductive region of predetermined electrical resistance indicative of calibration data relating to at least one test member in said cartridge, the calibration member being suitable for calibrating the test meter of claim 1.

22. A cartridge as claimed in claim 21, in which test members are arranged in a stack to be dispensed in sequence and a calibration member is at a position in the stack to be dispensed first.

23. A cartridge as claimed in claim 21, in which the predetermined electrical resistance of a conductive region of the calibration member is indicative of an expected response of a test member including a sample having a predetermined characteristic.

24. A cartridge as claimed in claim 23, in which the calibration data includes an expiry date.

25. A cartridge as claimed in claim 21, in which the calibration data includes temperature correction data.

26. A cartridge as claimed in claim 21, in which the cartridge contains a plurality of calibration members.

27. A method of calibrating a test meter using a calibration strip, the test meter being suitable for measuring a characteristic of a sample placed on a test strip dispensed from the meter, the test meter comprising at least two electrodes, an electrical power source, test strip dispensing mechanism, processor, a memory unit, the memory unit including data in a lookup table, the electrical power source supplying power to the electrodes, processor and memory device, the test strip dispensing mechanism being actuable to dispense a test strip from within the test meter, said test strip making contact with the electrodes as it is dispensed, the processor being electrically connected to the at least two electrodes to receive a signal from the electrodes indicative of the current passing between the electrodes, the processor comparing said signal with the lookup table to produce a signal indicative of a characteristic of a sample on a test strip, the calibration strip comprising at least one conductive region of predetermined electrical resistance corresponding to the expected electrical resistance of a test strip including a sample having a predetermined characteristic, wherein the method comprises the steps of:
a) inserting the calibration strip into the test meter;
b) using the dispensing mechanism to dispense said calibrating strip such that the or each conductive region makes contact with the electrodes;
c) using the processor to compare the signal received from the electrodes when in contact with a conductive region with the data in the lookup table for the predetermined characteristic; and
d) using the processor to alter the data in the lookup table in response to a difference between the signal and the data in the lookup table.

28. A method as claimed in claim 27, in which the calibrating strip has a plurality of conductive regions, each relating to a different predetermined characteristic of a sample on a test strip.

29. A method as claimed in claim 27, in which the test meter is adapted to receive a cartridge containing test strips and the dispensing mechanism is capable of dispensing a test strip from the cartridge, at least one calibrating strip being included in said cartridge.

30. A method as claimed in claim 29, in which the calibrating strip is dispensed prior to the first use of a strip from the cartridge.

31. A method as claimed in claim 27, in which the or each conductive region of the calibrating strip has a predetermined electrical resistance indicative of an expected signal from a plurality of test strips with which the calibrating strip is to be supplied.

32. A method as claimed in claim 27, in which the calibration strip further includes at least one region of predetermined electrical resistance indicative of temperature correction data.

33. A method as claimed in claim 27, in which the calibration strip further includes at least one region of predetermined electrical resistance indicative of an expiry date.
